(19) United States
(12) Patent Application Publication
(10) Pub. No.: US 2019/0071106 A1
(43) Pub. Date: Mar. 7, 2019

(54) METHODS AND SYSTEMS FOR WIRELESS TRAIN COMMUNICATIONS

(71) Applicant: Metrom Rail, LLC, Crystal Lake, IL (US)

(72) Inventor: Richard C. Carlson, Village of Lake in the Hills, IL (US)

(21) Appl. No.: 16/118,941

(22) Filed: Aug. 31, 2018

Related U.S. Application Data
(60) Provisional application No. 62/553,570, filed on Sep. 1, 2017.

(51) Int. Cl. B61L 15/00; B61L 27/00; B61L 27/04; B61L 25/02; B61L 23/20; H04W 4/42

(52) U.S. Cl. CPC B61L 15/0027; B61L 27/0005; B61L 27/04; B61L 25/021; H02S 99/00; B61L 23/20; H04W 4/42; B61L 2201/00; B61L 2205/00; B61L 25/025

(57) ABSTRACT

A plurality of wayside communication units may be configured for placement on or near path of trains. Each wayside communication unit may include a power component configured for generating and/or obtaining power for powering components of the wayside communication unit; a communication component configured for transmitting and/or receiving wireless signals; and one or more circuits that process signals and data, and perform one or more applications or functions relating to operations of the wayside communication unit. Each wayside communication unit may be configured to communicate signals and/or messages with one or more local control devices within a legacy train control system, and with each train-based device that moves within communication range of the wayside communication unit. The legacy train control systems may include communication-based train control (CBTC) based systems. The wayside communication units may be configured for utilizing ultra-wideband (UWB) based communications.

### CLAIM OF PRIORITY

This patent application makes reference to, claims priority to and claims benefit from U.S. Provisional Patent Application Ser. No. 62/553,570, filed on Sep. 1, 2017. The above identified application is hereby incorporated herein by reference in its entirety.

### TECHNICAL FIELD

Aspects of the present disclosure relate to communication solutions used in conjunction with railway systems. More specifically, various implementations of the present disclosure relate to wireless train communication system (WTCS) and use thereof in conjunction with railway systems.

### BACKGROUND

Various issues may exist with conventional approaches for communicating with trains. In this regard, conventional systems and methods, if any existed, for providing and/or supporting wireless communications with trains, particularly in conjunction with control of trains, may be costly, inefficient, and cumbersome. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for wireless train communication, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example conventional train control system.

FIG. 2 illustrates an example train control system that incorporates wireless train communication system (WTCS) components, in accordance with the present disclosure.

FIG. 3 illustrates an example train-based wireless train communication system (WTCS) unit, in accordance with the present disclosure.

FIG. 4 illustrates an example wayside wireless train communication system (WTCS) unit, in accordance with the present disclosure.

FIGS. 5A and 5B illustrate an example implementation of wayside wireless train communication system (WTCS) unit, in accordance with the present disclosure.

FIG. 6 illustrate an example wayside wireless train communication system (WTCS) based wayside node network, in accordance with the present disclosure.

### DETAILED DESCRIPTION OF THE INVENTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

Various implementations in accordance with the present disclosure are directed to wireless train communication solutions that may be used in conjunction with train control systems. In this regard, wireless train communication system (WTCS) as proposed in accordance with this disclosure is designed to utilize wireless technologies for optimal support of control functions. The wireless train communication system (WTCS) may utilize, for example, Ultra-Wide Band (UWB) technology. In this regard, the wireless train communication system (WTCS) may combine the strengths of an Ultra-Wide Band (UWB) based sensors and communication train control system with existing and conventional control systems, such as communication-based train control (CBTC) based systems. In this regard, CBTC systems may be used to automate train control processes. While CBTC systems wirelessly communicate with the trains, the topology is overall wired-based structure, which may greatly and negatively impacts installation time and cost.

Accordingly, the wireless train communication system (WTCS) solutions in accordance with the present disclosure may be used to mitigate such issues, such as using UWB technologies, to provide train control and sensory functions, which may be combined traditional systems, such as CBTC systems.

In this regard, conventional CBTC systems may rely on wireless links between trains to wayside nodes, to facilitate bi-directional transfer information. Critical information which is required includes train position (both linearly as well as the track ID), train speed, and if the wheels of the train are sliding or slipping. Train position may be calculated by putting an RFID tag on the track and having a corresponding reader installed under the train. Train speed may be calculated by integrating a multitude of rotary speed sensor into the gearbox, and or axle assembly of the train. Slip-slide detection is accomplished using complex multiple accelerometers mounted into the train. Many of these functions may be provided via WTCS based solutions (particularly using network comprising UWB based nodes) instead, however.

For example, using a network of UWB sensors located around the track, the train position may be calculated by ranging to the next or with multiple nodes, train speed may be accomplished by performing a delta-separation calculation between radios, etc. Slip-slide detection may not applicable with such measurement process, however. Another added benefit is cost and time. In this regard, installation processes associated with conventional CBTC solutions may be substantial—e.g., amounting to thousands of hours of wiring and equipment installation per train car. The WTCS based solutions (particularly using UWB based nodes) may require much simplified installation processes—e.g., requiring only hours of installation time per train car with no additional sensors required, with the end result being a more accurate and flexible system with minimal maintenance on the train cars, and with the elimination of certain dedicated components, such as track RFID transducers.

Further, WTCS networks (e.g., comprising UWB nodes) may be combined with conventional solutions (e.g., CBTC based systems) to offer additional capability above and beyond these conventional solutions may typically allow—e.g., double berthing, end of line protection, zero speed capability (e.g., CBTC requires that the train be driven for a distance until it can determine direction and speed), length of consist (by ranging the UWB radios both front and back of the train to known UWB locations on wayside, train length is easily calculated), etc. In addition, WTCS based solutions may provide additional functions beyond mere communication between trains and wayside nodes. For example, UWB wayside networks may be configured not only for use in supporting and facilitating communication between the wayside nodes and the train, but also to operate as sensor networks, may allow for eliminating conventional dedicated sensory systems (e.g., replacing the existing electro-mechanical sensors used in CBTC based solutions). In some instances, WTCS based solutions may incorporate use of additional communication links, between the wayside nodes, to enhance performance. For example, WTCS based wayside node network may be interconnected with fiber, to provide redundant data links.

An example system for wireless train communications, in accordance with the present disclosure, may be configured for operation in conjunction with legacy train control systems. The system may comprise a plurality of wayside communication units, configured for placement on or near path of trains. Each wayside communication unit comprises a power component configured for generating and/or obtaining power for powering components of the wayside communication unit; a communication component configured for transmitting and/or receiving wireless signals; and one or more circuits which may be configured for processing signals and data, and performing one or more applications or functions relating to operations of the wayside communication unit. Each wayside communication unit may configured to communicate signals and/or messages with one or more local control devices within a legacy train control system, and with each train-based device that moves within communication range of the wayside communication unit.

In an example implementation, the legacy train control systems may comprise communication-based train control (CBTC) based systems.

In an example implementation, the communication component may be configured for utilizing ultra-wideband (UWB) based communications with one or both of the one or more local device and train-based devices.

In an example implementation, the wayside communication unit may obtain information relating to trains associated with train-based devices that move within communication range of the wayside communication unit, and may provide the obtained information to the legacy train control system, via the one or more local control devices.

In an example implementation, the each of plurality of wayside communication units may be configured for detecting, monitoring, and/or tracking trains. The wayside communication units is configured for detecting, monitoring, and/or tracking trains, based on interactions with train-based devices associated with the trains

In an example implementation, the at least one of plurality of wayside communication units is configured for obtaining ranging related information for trains, based on interactions with train-based devices associated with the trains. The wayside communication unit may be configured for obtaining ranging based on ultra-wideband (UWB) signaling.

In an example implementation, the at least one of plurality of wayside communication units is configured for directly interacting with trains based on communications with train-based devices associated with the trains. The wayside communication unit, when directly interacting, may control one or more systems within the trains. The one or more systems within the trains may comprise automated braking, speed sensors, or operator displays.

In an example implementation, the power component may be configured to obtain power using one or more power harvesting techniques. The power component is configured to obtain power by harvesting solar energy.

In an example implementation, at least one of plurality of wayside communication units is configured for interacting with one or more other wayside devices. The one or more other wayside devices may comprise track switches and/or signals. The at least one of plurality of wayside communication units forwards control data from the legacy train control system to the one or more wayside devices.

In an example implementation, each wayside communication unit may comprise a housing for enclosing components of the wayside communication unit.

In an example implementation, each wayside communication unit may comprise a support structure for holding and supporting the wayside communication unit when placed on or near train tracks.

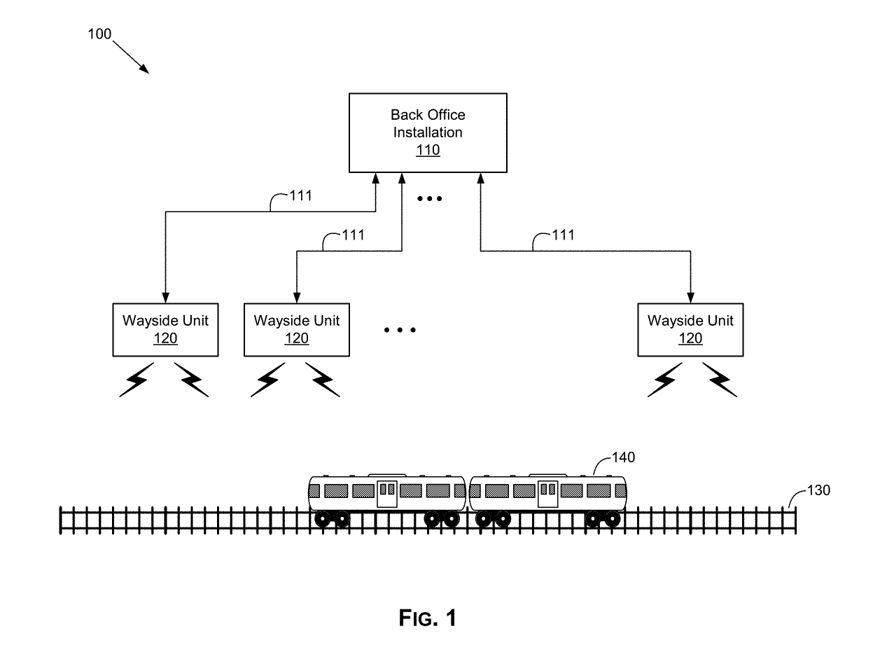

FIG. 1 illustrates an example conventional train control system. Shown in FIG. 1 is a conventional train control system 100 and an example use scenario thereof. In this regard, the train control system 100 may be a communication-based train control (CBTC) system.

The system 100 (as with other CBTC based systems) comprises a main (“back office”) installation 110 which controls all aspects of a train control system. The installation 110 is connected via wired connections 111 to a plurality of rail system wayside units 120 arranged on and/or near track(s) 130, to enable controlling the railway system infrastructure and components thereof, such as switches, signals, control relays, etc. The wayside units 120 may interact with train(s) 140 over wireless connections.

Various issues arise with use of such conventional systems. For example, in CBTC based systems (e.g., the system 100) deploying the wired wayside units typically takes the bulk of cost and installation time, as the wiring on the wayside is typically difficult in scope due to conditions, locations, and the requirements to suspend active service when servicing close to tracks.

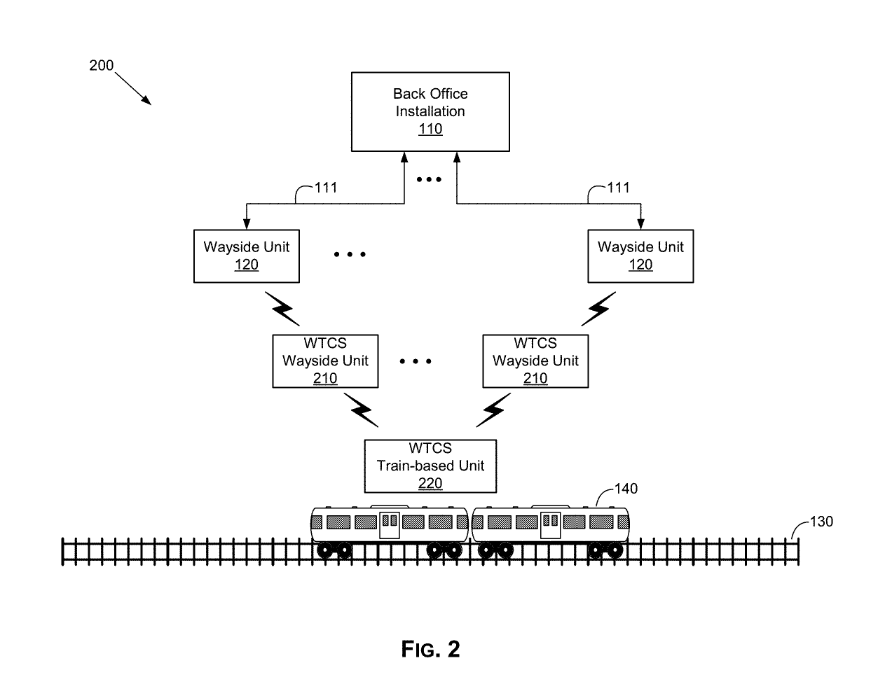

Accordingly, in various implementations in accordance with the present disclosure, wireless based communication systems may be utilized, such as in conjunction with existing conventional systems. An example implementation that utilizes wireless train communication system (WTCS) is described with respect to FIG. 2.

FIG. 2 illustrates an example train control system that incorporates wireless train communication system (WTCS) components, in accordance with the present disclosure. Shown in FIG. 2 is a wireless train communication and control system 200.

The system 200 comprises wireless train communication system (WTCS) based elements that are incorporate into a conventional train control system, such as the CBTC system 100 of FIG. 1. In this regard, wireless train communication system (WTCS) utilizes wireless technology, such as Ultra-Wide Band (UWB), for providing wireless communications to simplify and optimize train control and/or installation thereof. The use of UWB may be desirable, such as due to its wide frequency bandwidth, which makes particularly resistant to conditions associated with railway systems. For example, UWB may be un-effected by the normal mechanical obstructions and interfaces in train locations, such as supporting beams and other structures normally found in a subway tunnels or other track locations. Further, UWB signals may be used for different purposes—e.g., for communication, as well as other uses such as time of flight ranging, in which precise distances and rates of closure can be calculated for collision avoidance applications.

In WTCS based implementations, a network of UWB based communication radios may be placed alongside the track network (as well as on the trains) to provide UWB based communications (including when UWB signals are used for non-communicative purposes). For example, as shown in the example implementation shown in FIG. 2, the system 200 may comprise WTCS wayside units 210 and WTCS train-based units 220. The WTCS wayside units 210 may communicate data to and/or from the train 140 (which utilizes its own WTCS train-based units 220) as it passes on the track 130 within range of the radios of these units. The WTCS train-based units 220 may communicate, for example, such data as train location, speed, direction, other node data, etc. The WTCS wayside units 210 may be pass data wirelessly back to the conventional CBTC network (e.g., using wireless links to the CBTC wayside units 120). The CBTC system may then utilized the data obtained via the WTCS system to further enhance railway operations—e.g., to calculate safe train passage based upon train position and speed.

In some example implementations, the WTCS wayside units 210 may be powered in adaptive manner, such based on available conditions and/or resources for each installation location—e.g., by batteries, line power lines, solar, and/or energy harvesting methods.

In some example implementations, in addition to utilizing the WTCS in conjunction with safety control of the trains—e.g., calculation of train location within the network, the WTCS based components may also be used for other purposes. For example, WTCS components (e.g., the WTCS wayside units 210 and/or the WTCS train-based units 220) may wirelessly interface with other wayside assets, such as switches or signals. This may occur, for example, when the base CBTC system detects that a specific wayside item such as a switch must be activated. In this case, the CBTC system may wirelessly communicate to the WTCS system that an upcoming switch be activated, the WTCS system will then wirelessly communicate with the asset, with confirmation then sent back to the CBTC system that the switch had been activated.

In some example implementations, the WTCS system may also be used to perform other functions to “fill in gaps” of conventional CBTC systems. For example, the ranging function of the UWB radios in the WTCS system may be used to perform functions such as double berthing, where trains can stack up at stations at close proximity, being controlled using a distance-speed algorithm unique to the UWB radio set. Another “gap” would be end of line protection where a conventional CBTC system may not have the granularity required for accurately detecting speed and location to prevent such an accident, but again, using the UWB component, a speed-distance calculation can be performed to prevent such an accident.

In some example implementations, the WTCS system may be configured to interface directly with trains—e.g., to enable performing functions such as automated braking, also interfacing with RFID systems, speed sensors and or operator displays.

In some example implementations, each of the WTCS wayside units 210 may comprise a housing configured for enclosing various components of the unit, and/or allowing attachment to certain external elements or structures. In this regard, the housing may be constructed to be suitable for the intended operation environment and/or conditions of the WTCS wayside units 210 (e.g., being constructed to be very rigid, to withstand accidental impacts during deployment and/or when it knocked down), and to withstand environmental conditions associated with outside/external use (e.g., rain, extreme cold and/or heat, etc.).

In some example implementations, each of the WTCS wayside units 210 may comprise (or can be coupled to) a support structure configured for enabling placement or installation of the WTCS wayside units 210 to or near train tracks.

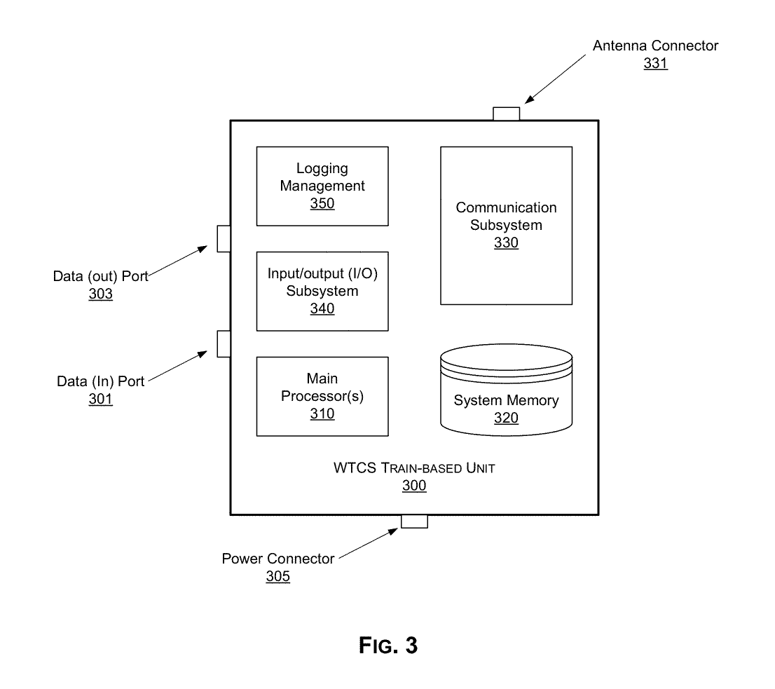

FIG. 3 illustrates an example train-based wireless train communication system (WTCS) unit, in accordance with the present disclosure. Shown in FIG. 3 is a train-based wireless train communication system (WTCS) unit 300.

The WTCS train-based unit 300 may comprise suitable hardware (including circuitry and/or other hardware components), software, and/or combination thereof for implementing various aspects of the present disclosure, particularly with respect to the train-mounted functionality in support of wireless train communication system (WTCS), as described with respect to FIG. 2.

As shown in the example implementation illustrated in FIG. 3, the WTCS train-based unit 300 comprises one or more main processors 310, a system memory 320, a communication subsystem 330, an input/output (I/O) subsystem 340, and a logging management component 350.

Each main processor 310 may comprise suitable circuitry operable to process data, and/or control and/or manage operations of the WTCS train-based unit 300, and/or tasks and/or applications performed therein. In this regard, the main processor 310 may configure and/or control operations of various components and/or subsystems of the WTCS train-based unit 300, by utilizing, for example, one or more control signals. The main processor 310 may comprise a general purpose processor (e.g., CPU), a special purpose processor (e.g., application-specific integrated circuit (ASIC)), or the like. The disclosure, however, is not limited to any particular type of processors. The main processor 310 may enable running and/or execution of applications, programs and/or code, which may be stored, for example, in the system memory 320. Alternatively, one or more dedicated application processors may be utilized for running and/or executing applications (or programs) in the WTCS train-based unit 300.

The system memory 320 may comprise suitable circuitry for permanent and/or non-permanent storage, buffering, and/or fetching of data, code and/or other information, which may be used, consumed and/or processed. In this regard, the system memory 320 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage devices. The system memory 320 may store, for example, configuration data, which may comprise parameters and/or code, comprising software and/or firmware, logging data, etc.

The communication subsystem 330 may comprise suitable circuitry operable to communicate signals from and/or to the electronic device, such as via one or more wired and/or wireless connections. In this regard, the communication subsystem 330 may be configured to support one or more wired or wireless interfaces, protocols, and/or standards, and to facilitate transmission and/or reception of signals to and/or from the WTCS train-based unit 300, and/or processing of transmitted and/or received signals, in accordance with the applicable interfaces, protocols, and/or standards. Examples of signal processing operations that may be performed by the communication subsystem 330 comprise, for example, filtering, amplification, analog-to-digital conversion and/or digital-to-analog conversion, up-conversion/down-conversion of baseband signals, encoding/decoding, encryption/decryption, and/or modulation/demodulation. For example, the communication subsystem 330 may be configured to support broadcast of alert related signals, via associated antenna(s). In this regard, the antennas may include internal antennas embedded within the WTCS train-based unit 300, or external antennas, coupled to the WTCS train-based unit 300, such as via antenna connector 331. The external antennas may include dedicated antennas, or may include suitable antennas already available on the train. The communication subsystem 330 (and related components) may be configured for supporting and utilizing ultra-wide band UWB based communications.

The I/O subsystem 340 may comprise suitable circuitry for managing user interactions with the WTCS train-based unit 300, such as to enable obtaining input from and/or providing output to device user(s). The I/O subsystem 340 may support various types of inputs and/or outputs, including, for example, video, audio, tactile, and/or textual. In this regard, dedicated I/O devices and/or components, external to (and coupled with) or integrated within the WTCS train-based unit 300, may be utilized for inputting and/or outputting data during operations of the I/O subsystem 340. Examples of such dedicated I/O devices may comprise user interface components or devices (e.g., displays or screens), audio I/O components (e.g., speakers and/or microphones), mice, keyboards, touch screens (or touchpads), and the like. In some instances, user input obtained via the I/O subsystem 340, may be used to configure and/or modify various functions of existing I/O components or subsystems on the train.

The logging management component 350 may comprise suitable circuitry for managing logging operations in the WTCS train-based unit 300. The logging operations may comprise compiling log files (stored in the system memory 320) containing data relating to alerts, as described above.

Further, while not shown in FIG. 3, the WTCS train-based unit 300 may also comprise component for managing power supply. In this regard, the WTCS unit 300 may be powered using power sources available on the train, with the power being drawn via a power connector 305, for example.

As noted above, as shown in the example implementation illustrated in FIG. 3, the WTCS train-based unit 300 may be implemented as multi-unit system, comprising multiple separate components (the WTCS train-based unit 300, the WTCS train-based unit antenna unit 320, and the WTCS train-based unit controller 330). In this regard, as noted each of the different physical unit may be configured for placement at particular location and/or position, selected for optimal performance with respect to functions and/or operations provided by that unit. For example, the WTCS train-based unit 300 may be configured for placement within the operator compartment (e.g., train cockpit) at position optimal for providing output to and/or receiving input from the operator (e.g., top of the dashboard). The WTCS train-based unit antenna unit 320, may be configured for placement outside (and on top) of the engine car. The WTCS train-based unit 300 may be configured for placement within the engine car, but out of the way (for convenience).

As the WTCS train-based unit 300 may house the bulk of the WTCS train-based unit resources (e.g., processing resources, storage resources, etc.), the WTCS train-based unit controller 330 may be configured to support connecting to and/or communicating with other devices, systems, and/or resources on the train that may be utilized in support of operations of the WTCS train-based unit 300. For example, the WTCS train-based unit 300 may comprise data ports 301 and 303, for enabling connecting the WTCS train-based unit 300 to the train, for extracting data from the train or its systems, and/or inputting data thereto (e.g., for (re)configuration), etc.

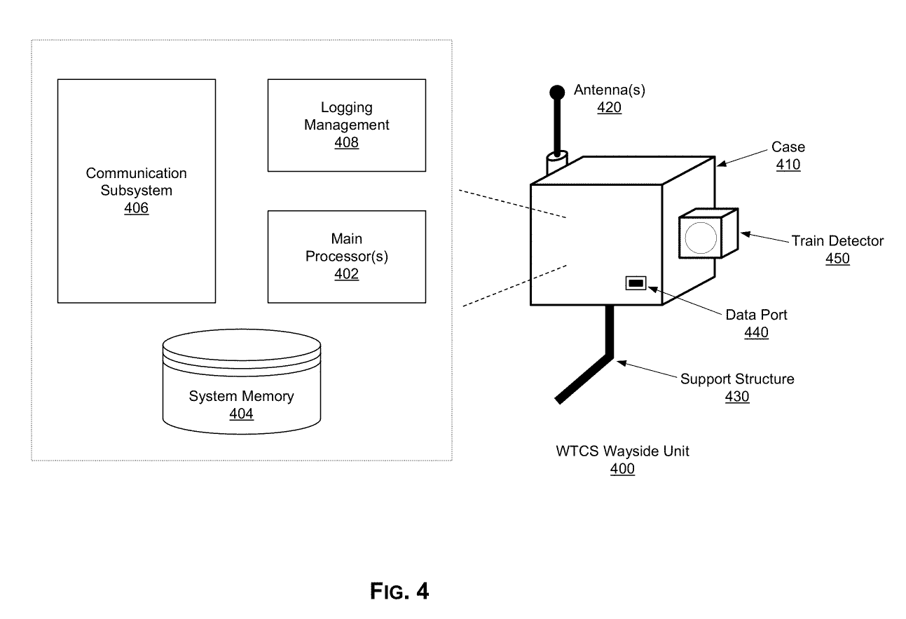

FIG. 4 illustrates an example wayside wireless train communication system (WTCS) unit, in accordance with the present disclosure. Shown in FIG. 4 is a WTCS wayside unit 400.

The WTCS wayside unit 400 may comprise suitable hardware (including circuitry and/or other hardware components), software, and/or combination thereof for implementing various aspects of the present disclosure, particularly with respect to the wayside functionality in support of wireless train communication system (WTCS), as described with respect to FIG. 2.

In the example implementation illustrated in FIG. 4, the WTCS wayside unit 400 may comprise a housing (or case) 410 for enclosing various components of the WTCS wayside unit 400. In this regard, the housing 410 may be constructed to be suitable for the intended operation environment and/or conditions of the WTCS wayside unit 400 (e.g., being constructed to be very rigid, to withstand accidental impacts during deployment and/or when it knocked down), and to withstand environmental conditions associated with outside/external use (e.g., rain, extreme cold/heat, etc.). The WTCS wayside unit 400 has one or more antennas 420, used in transmitting and/or receiving signals (e.g., communicating with legacy CBTC wayside units 120 and/or WTCS train-based units). Further, the WTCS wayside unit 400 may also comprise (or can be coupled to) a support structure 430, such as a rigid tripod, to enable placement of the WTCS wayside unit 400, such as near train tracks.

Internally, the WTCS wayside unit 400 may comprise suitable circuitry for performing various operations in support of its functions. For example, as shown in the example implementation illustrated in FIG. 4, the WTCS wayside unit 400 may comprise one or more main processors 402, a system memory 404, a communication subsystem 406, and a logging management component 408.

Each main processor 402 may comprise suitable circuitry operable to process data, and/or control and/or manage operations of the WTCS wayside unit 400, and/or tasks and/or applications performed therein. In this regard, the main processor 402 may configure and/or control operations of various components and/or subsystems of the WTCS wayside unit 400, by utilizing, for example, one or more control signals. The main processor 402 may comprise a general purpose processor (e.g., CPU), a special purpose processor (e.g., application-specific integrated circuit (ASIC)), or the like. The disclosure, however, is not limited to any particular type of processors.

The main processor 402 may enable running and/or execution of applications, programs and/or code, which may be stored, for example, in the system memory 404. Alternatively, one or more dedicated application processors may be utilized for running and/or executing applications (or programs) in the WTCS wayside unit 400.

The system memory 404 may comprise suitable circuitry for permanent and/or non-permanent storage, buffering, and/or fetching of data, code and/or other information, which may be used, consumed and/or processed. In this regard, the system memory 404 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage devices. The system memory 404 may store, for example, configuration data, which may comprise parameters and/or code, comprising software and/or firmware, logging data, etc.

The communication subsystem 406 may comprise suitable circuitry operable to communicate signals from and/or to the electronic device, such as via one or more wired and/or wireless connections. In this regard, the communication subsystem 406 may be configured to support one or more wired or wireless interfaces, protocols, and/or standards, and to facilitate transmission and/or reception of signals to and/or from the WTCS wayside unit 400, and/or processing of transmitted and/or received signals, in accordance with the applicable interfaces, protocols, and/or standards. Examples of signal processing operations that may be performed by the communication subsystem 406 comprise, for example, filtering, amplification, analog-to-digital conversion and/or digital-to-analog conversion, up-conversion/down-conversion of baseband signals, encoding/decoding, encryption/decryption, and/or modulation/demodulation. The communication subsystem 406 (and related components) may be configured for supporting and utilizing ultra-wide band UWB based communications, via the antenna(s) 420.

The logging management component 408 may comprise suitable circuitry for managing logging operations in the WTCS wayside unit 400. The logging operations may comprise compiling log files (stored in the system memory 404) containing data relating to alerts, as described above.

In some implementations, the WTCS wayside unit 400 may comprise a data port 440 for extracting data (e.g., log files) from and/or inputting data (e.g., (re)configuration data) into the WTCS wayside unit 400.

Further, the WTCS wayside unit 400 may incorporate additional and dedicated sensory elements, such as a train detector 450. In this regard, the train detector 450 may be operable to monitor, detect, and track approaching train, using one or more suitable technologies (e.g., visual, infrared, laser ranging, etc.), and/or to enable generating corresponding data (distance, relative speed, etc.). To that end, the WTCS wayside unit 400 may comprise suitable circuitry for managing sensors and sensory related functions. For example, such sensory circuitry may control the selection of detection and ranging technology implemented by the train detector 450, set the parameters required for its operations, and/or process information obtained via the train detector 450, to generate corresponding data (e.g., distance to approaching train, relative speed, etc.).

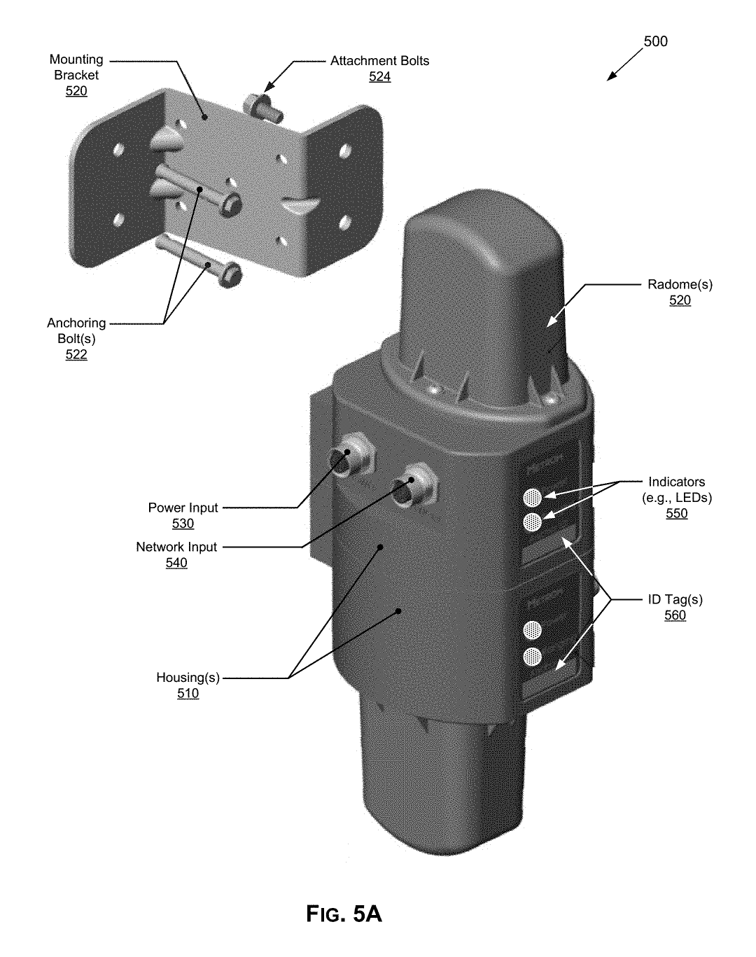

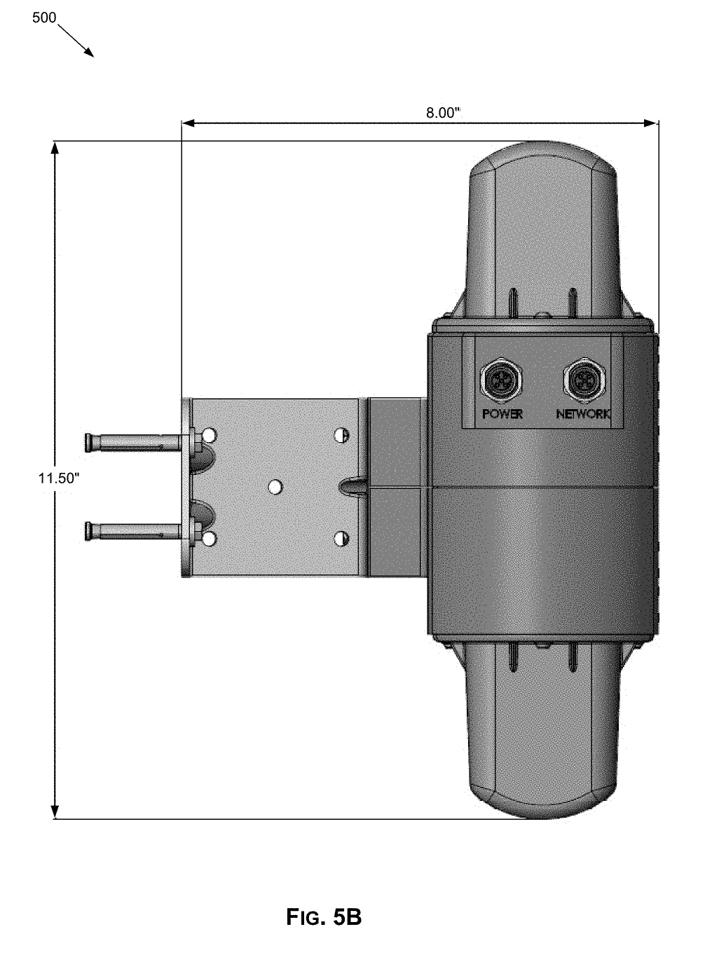

FIGS. 5A and 5B illustrate an example implementation of wayside wireless train communication system (WTCS) unit, in accordance with the present disclosure. Shown in Shown in FIGS. 5A and 5B is a WTCS wayside unit 500, which may be configured for installation on or near train tracks. In this regard, the WTCS wayside unit 500 may be substantially similar to and/or may represent an example implementation of the WTCS wayside unit 500, as described with respect to FIG. 4.

As shown in FIG. 5A, the WTCS wayside unit 500 may comprise housing(s) 510 for enclosing various components of the WTCS wayside unit 500. In this regard, the housing 510 may be constructed to be suitable for the intended operation environment and/or conditions of the WTCS wayside unit 500 (e.g., being constructed to be very rigid, to withstand accidental impacts during deployment and/or when it knocked down), and to withstand environmental conditions associated with outside/external use (e.g., rain, extreme cold/heat, etc.). For example, the housing 510 may be construed from coated aluminum. The WTCS wayside unit 500 may also have radome(s) 520 (constructed from, e.g., polycarbonate material), which may be attached to the housing(s) 510. The radome(s) 520 may be used to enclose components that may need to be implemented external to the housing 510, such as antennas, used in wirelessly transmitting and/or receiving signals, such with other WTCS wayside units, legacy CBTC wayside units 120, train-based WTCS units).

The WTCS wayside unit 500/housing 510 may incorporate a power input (connector/port) 530, which may be used in connecting the WTCS wayside unit 500 to power source (e.g., the power grid) to power the WTCS wayside unit 500. The WTCS wayside unit 500/housing 510 may also incorporate a network input (connector/port) 540, which may be used in connecting the WTCS wayside unit 500 to one or more wired-based networks (e.g., fiber). In this regard, the power input 530 and the network input 540 may be implemented adaptively to optimize performance. For example, the power input 530 and the network input 540 may use M12 connectors. In this regard, the power input 530 may utilize an A-Code connector, while the network input 540 may utilize a D-Code connector to prevent mismatching during installation.

The WTCS wayside unit 500/housing 510 may incorporate means for providing indications or other information. For example, indicators (e.g., LEDs) 550 may be incorporated into the housing 510, and may be configured to convey/indicate certain information (e.g., UWB radio status). Further, identification (ID) tag(s) 560 may be affixed/overlaid on a part of the outside of the housing 510, showing identification number(s) of the WTCS wayside unit 500.

As noted, the WTCS wayside units may comprise or be coupled to support structures, to enable placement or installation of units. For example, as shown in FIG. 5A, the WTCS wayside unit 500 may installed using a mounting bracket 520, which may be configured to attachment to the WTCS wayside unit 500 (e.g., via attachment bolts 524) on one side, and for anchoring on a structure (e.g., wall, via anchoring bolts 522, for example) on the other side. For example, the attachment bolts 524 may be 1/4-20 bolts, whereas the anchoring bolts 522 may be 1/4-20 concrete anchor bolts.

Support structures, such as the mounting bracket 520, may be configured for unique mounting environments and/or to accommodate particular mounting/installation requirements. For example, the mounting bracket 520 may be configured to allow mounting the WTCS wayside unit 500 in particular manner—e.g., being structured such that it allows mounting the main assembly (the housing 510) at particular distance, such as 8″, from the wall where it is to be mounted. Further, the mounting bracket 520 may incorporate holes for allowing for cable management and tie-down straps, thus ensuring that when the cables are connected, they should not inhibit the line of sight of the antennas. FIG. 5B illustrates the combination of the WTCS wayside unit 500 and the mounting bracket 520 attached together.

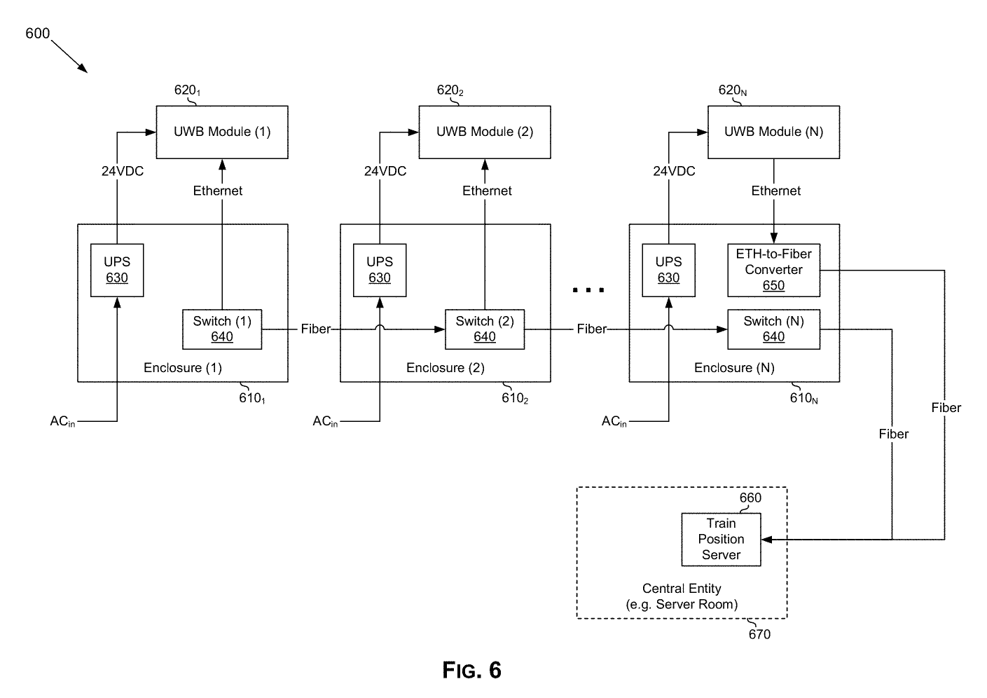

FIG. 6 illustrate an example wayside wireless train communication system (WTCS) based wayside node network, in accordance with the present disclosure. Shown in FIG. 6 is a wayside node network 600 that comprises a plurality of WTCS based wayside nodes, each of which may comprise suitable circuitry and other hardware.

The wayside node network 600 may be configured such that the nodes may be interconnected with wired-based (e.g., fiber) connections for enhanced performance. In this regard, such wired connectivity may provide redundant data links, to ensure that data may be exchanged (provided to and/or received from) among the nodes and/or between the nodes and centralized systems, when needed (e.g., in public safety scenarios).

For example, as shown in FIG. 6, each node may comprise an enclosure 610 (e.g., corresponding to housing 510 in the FIGS. 5A-5B) and a UWB module 620 (e.g., with the radomes 520). Each enclosure 620 may comprise a uninterruptible power supply (UPS) module 630, which may configured for receiving power input (e.g., alternative current (ACᵢₙ)) and processing it to generate a corresponding direct current based power supply (e.g., 24 VDC) that may be used in powering other components (e.g., the UWB modules 620). The nodes may be configured to support connectivity using wired-based technology, such as fiber. In this regard, each enclosure 610 may comprise switch 640, which comprise suitable circuitry for handling fiber based connections (e.g., between the different enclosures and/or to remote entities).

The switch(s) 640 may be configured to communicate via Ethernet based connection with the UWB modules 620. At least one of the enclosures 610 (e.g., enclosure 610N in FIG. 6) may further incorporate an Ethernet-to-Fiber convertor 650, to enable communicating information obtained from the UWB module(s) 620 to a remote entity (e.g., a train position server 660, located in a remote location 670, such as a server room).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for wireless train communications configured for operation in conjunction with legacy train control systems, the system comprises:
a plurality of wayside communication units, configured for placement on or near path of trains, wherein each wayside communication unit comprises:
a power component configured for generating and/or obtaining power for powering components of the wayside communication unit;
a communication component configured for transmitting and/or receiving wireless signals; and
one or more circuits operable to:
process signals and data, and
perform one or more applications or functions relating to operations of the wayside communication unit;
wherein the wayside communication unit is configured to communicate signals and/or messages with one or more local control devices within a legacy train control system, and with each train-based device that moves within communication range of the wayside communication unit.

2. The system of claim 1, wherein the legacy train control systems comprise communication-based train control (CBTC) based systems.

3. The system of claim 1, wherein the communication component is configured for utilizing ultra-wideband (UWB) based communications with one or both of the one or more local device and train-based devices.

4. The system of claim 1, wherein the wayside communication unit:
obtains information relating to trains associated with train-based devices that move within communication range of the wayside communication unit; and
provides the obtained information to the legacy train control system, via the one or more local control devices.

5. The system of claim 1, wherein each of plurality of wayside communication units is configured for detecting, monitoring, and/or tracking trains.

6. The system of claim 5, wherein each of plurality of wayside communication units is configured for detecting, monitoring, and/or tracking trains, based on interactions with train-based devices associated with the trains

7. The system of claim 1, wherein at least one of plurality of wayside communication units is configured for obtaining ranging related information for trains, based on interactions with train-based devices associated with the trains.

8. The system of claim 7, wherein the at least one of plurality of wayside communication units is configured for obtaining ranging based on ultra-wideband (UWB) signaling.

9. The system of claim 1, wherein at least one of plurality of wayside communication units is configured for directly interacting with trains based on communications with train-based devices associated with the trains.

10. The system of claim 9, wherein the at least one of plurality of wayside communication units, when directly interacting, controls one or more systems within the trains.

11. The system of claim 10, wherein the one or more systems within the trains comprise automated braking, speed sensors, or operator displays.

12. The system of claim 1, wherein the power component is configured to obtain power using one or more power harvesting techniques.

13. The system of claim 12, wherein the power component is configured to obtain power by harvesting solar energy.

14. The system of claim 1, wherein at least one of plurality of wayside communication units is configured for interacting with one or more other wayside devices.

15. The system of claim 14, wherein one or more other wayside devices comprise track switches and/or signals.

16. The system of claim 14, wherein the at least one of plurality of wayside communication units forwards control data from the legacy train control system to the one or more wayside devices.

17. The system of claim 1, wherein each wayside communication unit comprises a housing for enclosing components of the wayside communication unit.

18. The system of claim 1, wherein each wayside communication unit comprises a support structure for holding and supporting the wayside communication unit when placed on or near train tracks.
